(19) United States
(12) Patent Application Publication
(10) Pub. No.: US 2005/0026119 A1
(43) Pub. Date: Feb. 3, 2005

(54) Career development framework

(76) Inventors: Janet W. Ellis, McKinney, TX (US); Starr J. Dehn, Roseville, CA (US)

Correspondence Address: PERKINS COIE LLP;PATENT-SEA, P.O. BOX 1247, SEATTLE, WA, 98111-1247, US

(21) Appl. No.: 10/632,684

(22) Filed: Aug. 1, 2003

(51) Int. Cl. G06F 17/60; G09B 19/00

(52) U.S. Cl. 434/219; 705/11

(57) ABSTRACT

A career development framework that can be used to facilitate the development of many different business careers. The career development framework specifies required competencies for a career and requirements that need to be satisfied to attain each competency. A student of the career controls the pace and order in which the competencies are to be attained. A coach assists the student in satisfying the requirements and decides whether the student has satisfied the requirements and ultimately has attained the competency.

### TECHNICAL FIELD

The described method relates generally to career development and particularly to a structured method for attaining and maintaining relevant competencies of a career.

### BACKGROUND

Business career development has typically been achieved through educational programs at academic institutions and through workforce business training. These different methodologies of business career development each have advantages and disadvantages.

Various academic institutions offer courses and degrees directed to many types of business careers. For example, many colleges offer MBA programs that may include courses on project management, human resources, and so on. As another example, several colleges offer information technology degrees that may include courses in database administration, risk assessment, and so on. The people who enroll in these programs are typically full-time students who have not yet secured full-time employment in their chosen career. Many colleges, however, cater to part-time students who are employed full-time in a career that is possibly their chosen career. An advantage to educational programs is that they provide a broad foundation for a career. A disadvantage is that a broad foundation is neither tailored to the environment or needs of any particular company nor tailored to the needs of each individual student. Another disadvantage is that students are asked to apply their skills in hypothetical business environments rather than real-world business environments. Although some students may be asked to apply their skills to a project for a real company, projects selected by many companies are typically of little importance to the company and do not represent “real-world” projects.

Once a student graduates from an academic institution, the student may be employed full-time at a company in their chosen career. The typical company provides a business training model for future career development that is very different from that provided by an academic institution. The business training model typically provides training through business training seminars and through ad hoc on-the-job training. Business training seminars are very popular with companies and may range from very short training seminars (e.g., one hour) to multi-day training seminars. These business training seminars may be developed and presented by organizations that specialize in providing such seminars. In addition, many large companies may develop their own training seminars. The training seminars that are developed by a company may be more focused on that company's environment than those developed by outside organizations. An advantage of such business training seminars is that they provide employees with opportunities to learn new skills or to refresh existing skills in a structured environment. There are several disadvantages to business training seminars. Business training seminars are expensive and time consuming. Another disadvantage is that the training extends only over a short period of time, often with little or no follow-up. As a result, employees typically forget and never use the skills taught at seminars. As in academia, seminars are presented in the context of hypothetical projects. Finally, the performance of an employee at a seminar typically is not evaluated. As a result, the company does not know whether the employees who attend a seminar have obtained the desired competencies. In addition, companies may dictate which employees should attend which training seminars without regard to the desires of each employee. This can be detrimental to the effectiveness of the seminar and can use up an enrollment spot that might more effectively be used by another employee.

Companies also provide ad hoc on-the-job training for employees. An employee receives such training by being assigned to a project, completion of which requires the employee to develop or exhibit certain skills. Some employees may seek out mentors to help guide them through their on-the-job experiences; some companies may even assign mentors to employees. An advantage of ad hoc on-the-job training is that it is training within the company's business environment and training in a real-world environment from experienced staff. A disadvantage of such ad hoc on-the-job training is that there is no disciplined way to define required skills, to evaluate what skills an employee has developed, or to identify on-the-job projects through which the employee can learn specific skills.

It would be desirable to have a career development framework that would define skills needed to develop a threshold level of competencies for career development, provide a relatively objective way to evaluate whether an employee has developed particular skills, allow an employee to select the skills to be next developed, and allow a mentor to assist the employee in developing particular skills.

### BRIEF DESCRIPTION OF THE DRAWINGS

FIG. 1 is a flow diagram outlining the steps of a career development framework in one embodiment.

FIG. 2 is a display page providing overview information for a career as a project manager.

FIG. 3 is a display page illustrating detailed information about the team chartering competency.

FIG. 4 is a display page for chartering a team.

FIG. 5 illustrates a form used to assist in the baseline competency assessment process in one embodiment.

FIG. 6 illustrates a form for use in developing an action plan in one embodiment.

### DETAILED DESCRIPTION

A career development framework that can be used to facilitate the development of many different business careers is provided. In one embodiment, the career development framework specifies required competencies for a particular career and the requirements that need to be satisfied to attain each competency. A student of the career (e.g., an employee of a company who wants to learn the career) controls the pace at which, and the order in which, the competencies are to be attained. When the student decides to start working on attaining a competency, the student is assigned a “coach” or expert in that competency. The student and coach decide on how the requirements of the competency are to be satisfied by working on projects or other tasks for their company. The coach assists the student in satisfying the requirements and decides whether the student has ultimately satisfied the requirements and attained the competency. The career development framework overcomes many of the disadvantages of prior career development techniques by providing training in a real-world environment, objective guidelines for defining and attaining competencies, a student-selected pace, technical resources, and coaching assistance.

The career development framework provides that competencies for a particular career, along with the requirements needed to demonstrate that each competency has been attained, are established. For example, for a project manager career the competencies may include meeting management, project risk management, project chartering, and so on. The requirements of a competency typically may include both knowledge and skill requirements. For example, a knowledge requirement for the project risk management competency may be to describe the elements and timing for risk management reporting, and a skill requirement may be to complete the risk management reporting requirements of a project in accordance with stated schedules. Because a particular career may have many different competencies, the career development framework may allow the competencies to be organized into competency areas. For example, the meeting management competency may be in an interpersonal skills and communication competency area along with an effective listening competency. The competencies and requirements are preferably written in a clear and concise manner that can easily be understood by any student. One skilled in the art will appreciate that the career development framework can be used in the development of any business and nonbusiness career for which competencies and requirements can be established.

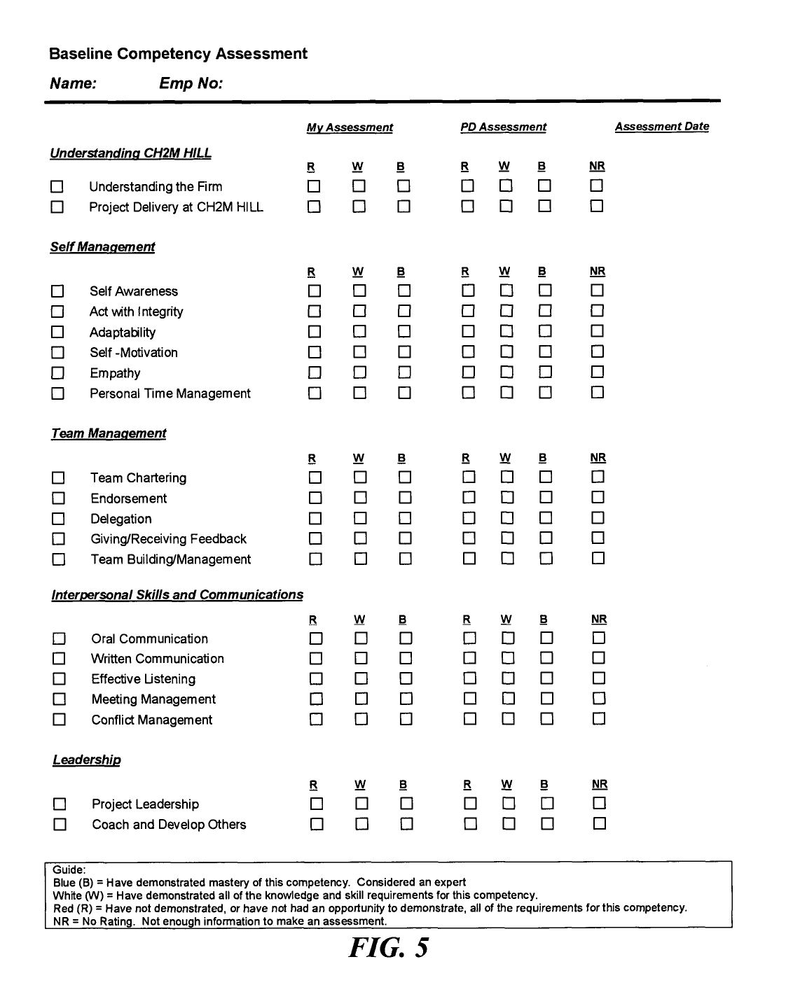

After the competencies and requirements are identified for a particular career, students are ready to start using the career development framework to develop their careers. The career development framework provides that a baseline assessment should initially be performed on the student. The baseline assessment is intended to identify the competencies that the student has already attained. For example, a student who has assisted a project manager in various projects may be competent in project risk management based on that experience. To perform the baseline assessment, the student designates the competencies that the student believes have already been attained (i.e., “self-assessment”). In addition, if the student is currently working in the career, then managers of the student may be asked to provide their assessment as to which competencies the student has already attained. When there is agreement between the student and the managers, the competencies are considered attained. FIG. 5 illustrates a form used to assist in the baseline assessment process in one embodiment. Any significant differences between the self-assessment and the assessment of the managers need to be resolved. A coach might also be assigned to ascertain whether the student has indeed attained a particular competency. The coach may discuss the requirements with the student or others and review the student's educational and business background to determine whether the student has satisfied the knowledge and skill requirements of the competency.

Whether or not the student has attained any of the competencies, the career development framework provides that from time-to-time the student should identify the competencies that the student next wants to attain. For example, the student may identify the competencies during normal semiannual or annual performance reviews. Because the student identifies the competencies to be next attained, the career development framework provides a self-paced approach to learning. Once the competencies are identified, a coach is assigned for each competency to assist the student in attaining that competency and to evaluate whether the student has satisfied all the requirements of the competency and thus has attained that competency. A coach is a person who is generally recognized as having achieved a very high level of proficiency in that particular competency. The coach may help the student identify various projects or tasks within the company that the student can work on to satisfy the requirements of the competency. Thus, the student learns by doing in a real-world environment. Once all the competencies for the career have been attained, the student has successfully demonstrated a threshold level of knowledge and skills for that career.

The baseline assessment process and the developmental process of attaining competencies may also be used to help a student attain a high level of proficiency in a competency, rather than just a threshold level. After a baseline assessment or the attainment of a competency, the student and the student's manager or coach may decide that the student is particularly strong in a competency, and they may devise a developmental action plan to build on the student's strength. The developmental action plan will address ways to increase the depth and breadth of the student's knowledge and skills of the competency to become very proficient in the competency. Thus, the career development framework can be used to help develop an expert level in a competency, rather than just a threshold level in the competency.

The career development framework provides various resources to assist a student in satisfying the requirements of the competencies. These resources may include collections of articles, books, videotapes, names of experts, and so on organized by competency and requirement so the student can obtain the needed knowledge to satisfy the knowledge requirements. The career development framework may also provide guidance on various tasks or projects that may be available to demonstrate a skill requirement. In one embodiment, the career development framework provides these resources via a computer system. The computer system may also include tools for tracking each student's career development, including tools for tracking the requirements that have been satisfied and the competencies that have been attained. The computer system may also provide information on those who are qualified to act as coaches for each competency.

In one embodiment, each competency consists of four components: objective, knowledge and skill requirements, guidance, and learning resources. The objective states the purpose of the competency. For example, the objective of the project risk management competency may be to “demonstrate ability to identify potential/real risk and implement management, mitigation, and/or optimization actions.” The requirements include knowledge and skill requirements. The knowledge requirements identify the things the student needs to know, and the skill requirements identify the behavior of a student that is needed to demonstrate that the competency has been attained. The requirements allow for consistent evaluation of all students in the same career. The guidance provides examples of how the requirements can be demonstrated. Guidance is not meant to extend the requirements but is offered to help clarify them. The learning resources provide information sources needed to satisfy the knowledge requirements. The learning resources may include web-based tools, books, videos, CDs, and online courses.

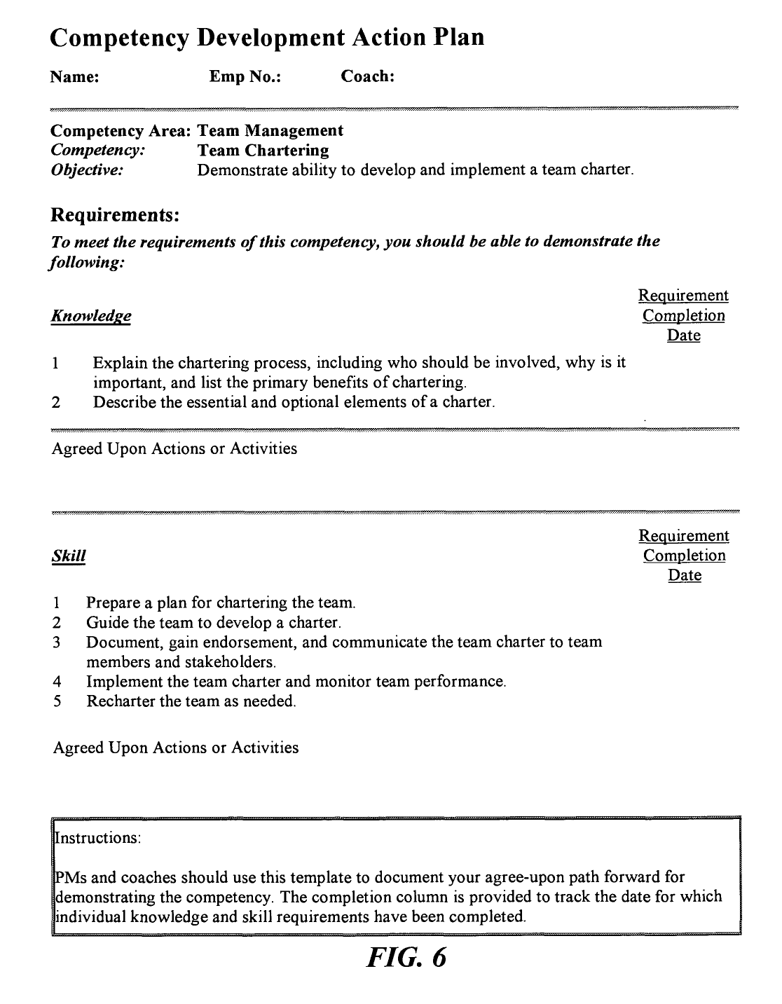

Competency is attained when the student consistently satisfies the knowledge and skill requirements of a competency. A one-time demonstration of a skill requirement is not sufficient—rather, the student needs to consistently demonstrate the skill requirement over time. To demonstrate that the competency has been attained, the student first needs to become familiar with the requirements of the competency. The student then selects a coach for that competency, a choice that needs to be endorsed by the student's manager. The student may consider pairing with another student to work as a team on satisfying the requirements, but each student needs to demonstrate competency individually. The student and the coach then meet to discuss how the competency should be demonstrated by developing a competency development action plan. FIG. 6 illustrates a form for use in developing an action plan in one embodiment. The action plan outlines the path toward obtaining and demonstrating competency. During the meeting, the coach may want to assess whether the student has already satisfied some of the knowledge requirements so the action plan can be customized accordingly. The action plan may include a completion date for each requirement. The student then does what is necessary to demonstrate in a way acceptable to the coach that each requirement has been satisfied. When the student believes all the requirements of a competency have been satisfied, the student should provide the coach with evidence that the requirements have been satisfied. This evidence may include reports written by others, project schedules, and so on. If the evidence is acceptable to the coach, the competency is considered attained. If the evidence is not acceptable, then the coach and the student will agree on a follow-up action plan.

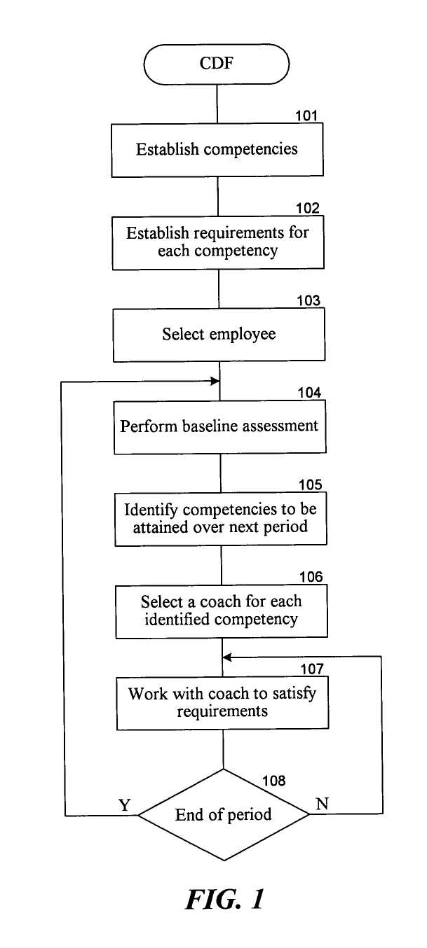

FIG. 1 is a flow diagram outlining the steps of the career development framework in one embodiment. In step 101, the competencies for the career are established. The competencies may be further organized into competency areas. In step 102, the knowledge and skill requirements are established for each competency. In addition, the objective, the guidance, and the learning resources are defined in step 102. The guidance and learning resources may change over time based on the experience of the students and the availability of new resources. In step 103, a student is selected to develop the career. In steps 104-108, the career is developed by successively identifying competencies to be attained next. In step 104, the baseline assessment is performed. A baseline assessment may be performed at various times to assess whether the student may have acquired knowledge and skills applicable to competencies other than those identified by the student. For example, a student may attain a competency in team building when working on attaining a competency in delegation. In addition, the periodic performance of the baseline assessment will help ensure that the student is still at or above the threshold for all requirements of the competencies that have already been attained. If the student is not currently demonstrating the requirements of a previously attained competency, then an action plan can be developed to reestablish that competency. In step 105, the student identifies the competencies that are to be attained during the next period (e.g., in conjunction with a performance review cycle). In step 106, a coach is selected for each identified competency. In step 107, the student attempts to satisfy the requirements, calling upon the coach as needed for assistance. In step 108, if it is the end of the period, then the student identifies the competencies to be attained next, else the student continues to work on the requirements that have not yet be satisfied and may perform an additional baseline assessment.

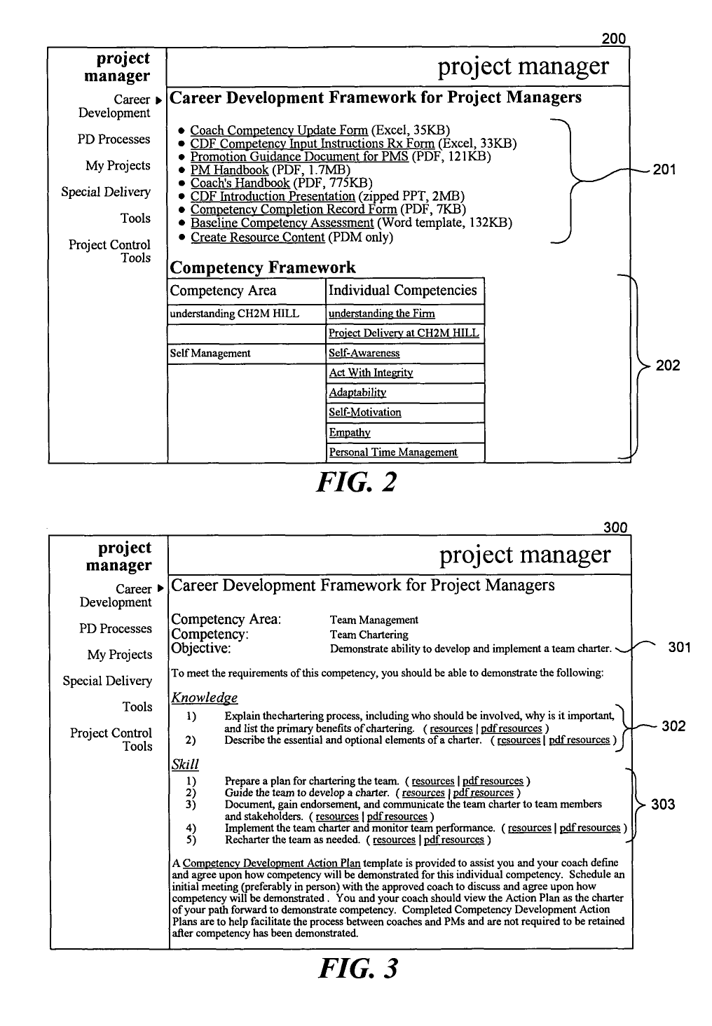

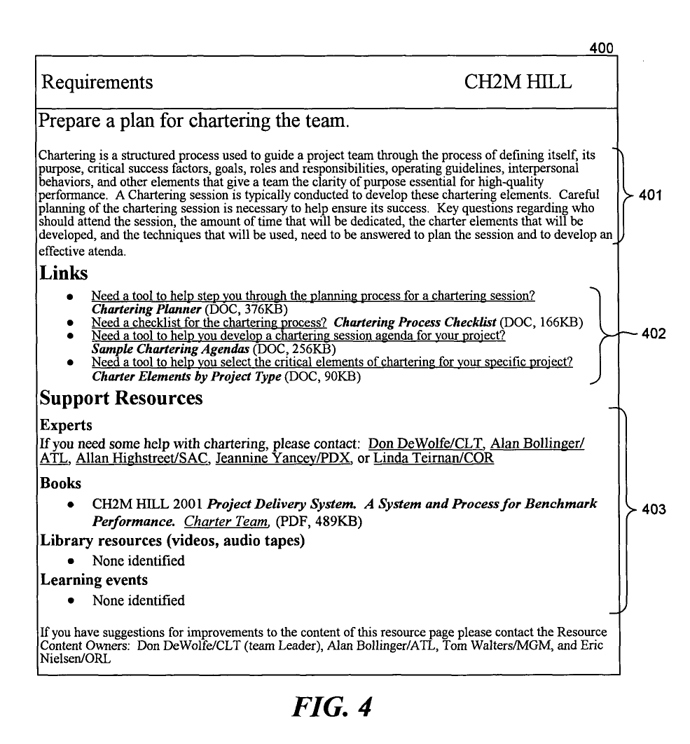

FIGS. 2-4 illustrate display pages of a web-based tool that supports the career development framework in one embodiment. FIG. 2 is a display page providing overview information for the project manager career. Display page 200 includes an overview links area 201 and a competency framework area 202. The overview links include links to various documents that provide information on the career development framework (e.g., project manager handbook) and various forms (e.g., baseline competency assessment form). These documents and forms may be provided in various formats such as in a portable document format, an HTML document format, and so on. The competency framework area lists each competency area for the career along with the individual competencies. Each individual competency may be a link to a display page that provides further detail about the competency. FIG. 3 is a display page illustrating detailed information about the team chartering competency. Display page 300 includes an objective 301, knowledge requirements 302, and skill requirements 303. The requirements include links to various resources and guidance related to the requirement. FIG. 4 is a display page chartering a team. Display page 400 includes a requirement overview area 401, a links area 402, and a support resources area 403. The requirement overview area includes an overview of the requirement. The links area contains links to various forms and documents that may be needed to satisfy the requirement. The support resources area identifies experts relating to that requirement and provides references to various articles and books that can provide background information on the requirement.

Tables 1 to 35 outline the objective and requirements of each of the competencies for the project manager career.

TABLE 1
Competency Area: Understanding CH2M HILL
Competency: Understanding the Firm Objective
Understand the vision, mission, values, core businesses, strategic
objectives, clients, services, core business processes, and
operational practices of CH2M HILL
Learning Outcomes

| | Knowledge Component: to demonstrate competence in this |
|---|---|
| K No. | area, a PM will be able to do the following: |
| 1 | Relate a brief history of CH2M HILL, including an |
| | explanation of how the firm was started and a |
| | description of the key factors and/or critical events |
| | that have had an important influence on the firm. |
| 2 | Explain what we do by describing the most common |
| | types of services, projects, and work that each |
| | of CH2M HILL's family of companies and business |
| | groups provide to customers. |
| 3 | Explain what the firm stands for and believes in by |
| | describing its mission and core values. |
| 4 | Describe whom we serve by listing key business |
| | customers of CH2M HILL. |
| 5 | Describe the firm's primary value proposition by |
| | providing an example of the application of the |
| | value proposition in the marketplace. |
| 6 | Describe how the firm is structured by defining |
| | the business group operating models (e.g., global |
| | business group-driven, GBG-regional partnership) |
| | and explaining how the GBG, regional business |
| | group operations, regions, and different legal |
| | entities work. |
| 7 | Describe how we do business by giving an overview of |
| | core business processes (i.e., scientific method, |
| | 4P, and PD), explaining how these processes relate |
| | within the functional organization of the firm, and |
| | identifying the primary focus and objectives of |
| | each process. |
| 8 | Describe the overall direction of the firm by |
| | restating the firm's short-term and long-term goals |
| | and providing examples of how these are being |
| | translated into new or expanded markets/services. |
| 9 | Describe the overall direction of one's business |
| | group by summarizing the vision, strategic |
| | direction, and short- and long-term goals. |
| 10 | Explain where one fits within the organization by |
| | describing the CH2M HILL business model, where one |
| | connects into the firm, and how one contributes |
| | to the firm's success. |
| 11 | Explain how the firm makes money by describing the |
| | basic financial operating model of the firm. |
| 12 | Explain the fundamental elements of the engineering |
| | consulting business by describing the industry's |
| | basic business model, economics, market outlook, |
| | market segmentation, competitive landscape (including |
| | CH2M HILL's position in the market), and |
| | customer base. |
| Applicable | Skill Component: to demonstrate competence in this |
| K Nos. | area, a PM will do the following: |
| | not applicable |

TABLE 2
Competency Area: Understanding CH2M HILL
Competency: Project Delivery at CH2M HILL Objective
Understand project delivery history, strategic objectives, system &
components, project-level application, and organizational
support resources
Learning Outcomes

| | Knowledge Component: to demonstrate competence in this |
|---|---|
| K No. | area, a PM will be able to do the following: |
| 1 | Define PDS at CH2M HILL by describing each of |
| | its underlying principles. |
| 2 | Explain why and how CH2M HILL developed PDS and |
| | describe the firm's vision for project delivery. |
| 3 | Explain what it means to be a Project-Centered |
| | Organization and describe the activities we are |
| | pursuing as a firm to become more |
| | project-centered. |
| 5 | List and describe the individual roles and responsibilities |
| | of the client, the project manager, and the project team |
| | in the successful completion of a project. |
| 6 | Give an overview of each step of the PD process and |
| | describe how each step contributes to the successful |
| | completion of a project. |
| 7 | List and describe when and how to use each of the |
| | firm's “standard” project delivery tools. |
| 8 | Explain the various personnel/team relationships that |
| | exist within the firm's overall Project Delivery |
| | structure, including: |
| | PM and Project Team |
| | PM and Project Delivery Team |
| | PDManager and Project Delivery Team |
| | PDM and PDD |
| | PDD, PD PGM, and PDLT |
| 9 | Explain why safety is an essential element of project |
| | delivery and provide an overview of how health, |
| | safety, and the environment (HS&E) is addressed |
| | within the PD process. |
| 10 | Explain why quality is an essential element of project |
| | delivery and provide an overview of how quality |
| | is addressed within the PD process. |
| 11 | Describe the business partner concept and explain how |
| | the PM may interface with each of the following as |
| | business partners on a project. |
| 12 | Explain how the firm measures success in project |
| | delivery on an individual project basis and at the |
| | firm level. |
| 13 | List and describe in detail the PM's roles and |
| | responsibilities. |
| 14 | Explain the Project Management Development Framework |
| | and how a PM can use the Framework to meet individual |
| | and career development needs. |
| 15 | Describe the PM career path, including key components |
| | used to evaluate progression from one level |
| | to the next. |
| Applicable | Skill Component: to demonstrate competence in this |
| K Nos. | area, a PM will do the following: |
| | not applicable |

TABLE 3
Competency Area: Self-Management
Competency: Self-Awareness Objective
Understand and develop oneself to further one's
ability to lead and manage others.
Learning Outcomes

| | Knowledge Component: to demonstrate competence in this |
|---|---|
| K No. | area, a PM will be able to do the following: |
| 1 | Explain the difference between values and principles. |
| 2 | Define what a vision is and why it is important. |
| 3 | Understand the importance of identifying one's values, |
| | principles, and vision. |
| 4 | Understand the link between feelings and what a |
| | person thinks, does, and says by providing an |
| | example of how feelings can affect one's |
| | performance. |
| 5 | Describe how biases and preferences affect |
| | decision making. |
| 6 | Recognize how one's values and principles impact |
| | decisions and actions. |
| 7 | Identify one's own strengths, weaknesses, and |
| | central tendencies. |
| 8 | Identify one's own interests and passions. |
| 9 | Understand the value of reflective learning. |
| 10 | Understand the value of self-development and |
| | lifelong learning. |
| Applicable | Skill Component: to demonstrate competence |
| K Nos. | in this area, a PM will do the following: |
| 4, 8 | Regularly ask for feedback from clients, coworkers, |
| | and supervisors. |
| 1-10 | Commit to a self-development program. |
| 7-10 | Complete one or more firm-endorsed self- |
| | assessment evaluations. |

TABLE 4
Competency Area: Self Management
Competency: Act with Integrity Objective
Demonstrate application of principled leadership.
Learning Outcomes

| | Knowledge Component: to demonstrate competence in this |
|---|---|
| K No. | area, a PM will be able to do the following: |
| 1 | Describe the firm's vision and values as they relate |
| | to integrity. |
| 2 | Explain the firm's policies as they relate to integrity. |
| 3 | Define principled leadership by explaining what it is, |
| | why it is important, and the benefits that it |
| | provides the individual and the firm. |
| 4 | Relate the importance of taking responsibility for one's |
| | own actions and performance by providing an example of |
| | how one's personal actions have direct |
| | business consequences. |
| Applicable | Skill Component: to demonstrate competence in this area, |
| K Nos. | a PM will do the following: |
| 3 | Conduct his or herself in a principled manner that |
| | reflects the firm's vision, values, and policies |
| | (including our Business Conduct Policy) as they |
| | relate to integrity. |
| 1-4 | Make decisions founded on ethical principles and |
| | in accordance with the firm's vision, values, and |
| | policies. |

TABLE 5
Competency Area: Self-Management
Competency: Adaptability Objective
Demonstrate resilience and flexibility in managing one's response to
competing demands, competing priorities, and change.
Learning Outcomes

| | Knowledge Component: to demonstrate competence in |
|---|---|
| K No. | this area, a PM will be able to do the following: |
| 1 | Describe the firm's strategies and business priorities. |
| 2 | Describe the responsibilities and expectations of one's |
| | role(s) in the firm. |
| 3 | Explain how one's role fits into the bigger picture of |
| | attaining the vision and goals of the firm. |
| 4 | Understand the importance of recognizing, understanding, |
| | and dealing with change, including the ability to deal |
| | with issues and projects/tasks that lie at the edges of |
| | one's “comfort zone.” |
| 5 | Recognize the importance of being open to new |
| | ideas/innovation. |
| 6 | Recognize the importance of being open to diversity of |
| | thought/ideas and differing communication styles. |
| Applicable | Skill Component: to demonstrate competence in this |
| K Nos. | area, a PM will do the following: |
| 1-5 | Evaluate and prioritize competing demands to achieve |
| | endorsed objectives. |
| 1-6 | Show resilience in the face of barriers, constraints, |
| | frustrations, or adversity. |
| 2, 4 | Demonstrate accountability by consistently meeting |
| | commitments and keeping promises. |
| 4 | Demonstrate flexibility by adopting new roles, |
| | tools, and processes as required to remain |
| | effective in the face of change. |

TABLE 6
Competency Area: Self-Management
Competency: Self-Motivation Objective
Demonstrate a commitment to pursuing goals and objectives.
Learning Outcomes

| | Knowledge Component: to demonstrate competence in this |
|---|---|
| K No. | area, a PM will be able to do the following: |
| 1 | Describe the emotional tendencies that guide or facilitate |
| | reaching goals. |
| 2 | Discuss how one's work relates to the larger mission of |
| | the firm by providing specific examples of how one's |
| | activities of today contribute to the firm's/business |
| | group's results of today and business of the future. |
| 3 | Describe how establishing performance criteria/ |
| | standards/benchmarks for oneself can lead to improved |
| | personal performance and contribute to the |
| | firm's performance. |
| Applicable | Skill Component: to demonstrate competence in this |
| K Nos. | area, a PM will do the following: |
| 1-3 | Set individual goals that are aligned to the team's/ |
| | firm's strategies, priorities, and objectives. |
| 1-3 | Respond to setbacks and obstacles by adjusting methods, |
| | tasks, priorities, etc. to ensure achievement of |
| | agreed-upon objectives. |
| 1-3 | Actively seek out opportunities and assignments that |
| | will stretch one's thinking and capabilities. |

TABLE 7
Competency Area: Self-Management
Competency: Empathy Objective
Demonstrate ability to act based on an awareness and understanding
of the diverse needs and perspectives of key stakeholders.
Learning Outcomes

| | Knowledge Component: to demonstrate competence in |
|---|---|
| K No. | this area, a PM will be able to do the following: |
| 1 | Recognize and be open to others' feelings, needs, |
| | perspectives, and concerns. |
| 2 | Recognize the organizational, political, cultural, |
| | or other dynamics affecting individual stakeholders. |
| 3 | Recognize one's personal and cultural bias |
| | and preferences. |
| 4 | Describe how to recognize and value differences. |
| Applicable | Skill Component: to demonstrate competence in this |
| K Nos. | area, a PM will do the following: |
| 1-4 | Demonstrate awareness of other's feelings, needs, |
| | perspectives and concerns in verbal communications |
| | by seeking to understand before responding. |
| 3-4 | Be aware of and challenge bias and intolerance |
| | in others. |
| 4 | Facilitate achievement of “win-win” outcomes through |
| | the collaboration of an appropriately diverse |
| | stakeholder base. |
| 4 | Seek feedback from clients, coworkers, supervisors, |
| | and other stakeholders regarding one's actions. |

TABLE 8
Competency Area: Self-Management
Competency: Personal Time Management Objective
Demonstrate ability to manage time for the benefit of oneself,
one's team, our clients, and our business.
Learning Outcomes

| | Knowledge Component: to demonstrate competence in this |
|---|---|
| K No. | area, a PM will be able to do the following: |
| 1 | Explain the principles of time management to others. |
| 2 | Relate the importance of identifying and maintaining an |
| | appropriate “work-life” balance by providing an |
| | example from one's current circumstances. |
| 3 | Describe the different time management styles and |
| | associated tools. Identify the pros and cons of each |
| | style. |
| 4 | Describe the process to follow to recognize and deal |
| | with nonpriority issues/tasks that adversely impact |
| | one's efficient/effective use of time. |
| Applicable | Skill Component: to demonstrate competence in this area, |
| K Nos. | a PM will do the following: |
| 1-4 | Develop and implement a system for managing multiple |
| | priorities and ensuring follow-through of key tasks. |
| 3-4 | Explain and demonstrate how to implement a strategy |
| | for handling interruptions and managing multiple |
| | priorities. |
| 4 | Recognize and address recurring issues/tasks that |
| | adversely impact the use of time to accomplish |
| | required tasks and/or targeted objectives. |

TABLE 9
Competency Area: Team Management
Competency: Team Chartering Objective
Demonstrate ability to develop and implement a team charter.
Learning Outcomes

| | Knowledge Component: to demonstrate competence in this |
|---|---|
| K No. | area, a PM will be able to do the following: |
| 1 | Explain the chartering process, including who should be |
| | involved, why it is important, and listing the primary |
| | benefits of chartering. |
| 2 | Describe the essential and optional elements of a charter. |
| 3 | Define the process to follow to charter a team. |
| Applicable | Skill Component: to demonstrate competence in this area, |
| K Nos. | a PM will do the following: |
| 1-3 | Build a plan for chartering the team. |
| 3 | Guide the team to develop a charter and recharter, |
| | as needed. |
| 1-3 | Document and communicate the team charter to team |
| | members and stakeholders. |
| 1 | Implement the team charter. |
| 1 | Assess the team's chartering activity using process |
| | improvement skills as needed to sustain effective |
| | team performance. |

TABLE 10
Competency Area: Team Management
Competency: Endorsement Objective
Demonstrate ability to develop and apply a process to gain endorsement
of the charter and workplan by the key stakeholders over the
life of the project.
Learning Outcomes

| | Knowledge Component: to demonstrate competence in this |
|---|---|
| K No. | area, a PM will be able to do the following: |
| 1 | Understand the endorsement process and describe the |
| | required elements of the process. |
| 2 | Describe the goals and benefits of endorsement. |
| 3 | Describe and demonstrate the techniques used to gain |
| | and sustain endorsement. |
| 4 | Explain how to identify and involve stakeholders. |
| Applicable | Skill Component: to demonstrate competence in this area, |
| K Nos. | a PM will do the following: |
| 1-4 | Gain endorsement of the charter and workplan from the |
| | identified stakeholders. |
| 3-4 | Identify and undertake alternative strategies if a |
| | stakeholder resists formal endorsement. |
| 4 | Assess the extent to which stakeholders support the |
| | charter and workplan, and their commitment towards |
| | adhering to them. Develop and implement strategies |
| | to address key issues that are causing less than |
| | full team endorsement. |

TABLE 11
Competency Area: Team Management
Competency: Delegation
Objective
Demonstrate ability to organize and conduct work
through the completion of tasks by others.
Learning Outcomes

| | Knowledge Component: to demonstrate competence in this |
|---|---|
| K No. | area, a PM will be able to do the following: |
| 1 | Differentiate between tasks that should or should not |
| | be delegated. |
| 2 | Identify likely support resources that can effectively |
| | accomplish work delegated by a PM and describe how to |
| | evaluate employees' knowledge/skill to identify who |
| | can complete delegated tasks. |
| 3 | Explain how to communicate expectations, authority, |
| | and accountability. |
| 4 | Describe methods used to track progress of |
| | delegated tasks. |
| 5 | Explain how to recognize and avoid potential pitfalls when |
| | delegating tasks. |
| 6 | Explain the benefits of appropriately delegating work |
| | and describe the challenges faced when transitioning |
| | from “doer” to “delegator.” |
| Applicable | Skill Component: to demonstrate competence in this area, |
| K Nos. | a PM will do the following: |
| 1 | Determine which tasks are appropriate to delegate |
| | and which are not. |
| 2 | Evaluate employees' knowledge/skills prior to delegating |
| | tasks to ensure his or her ability to complete the task |
| | is in accordance with stated criteria. |
| 3 | Communicate criteria and expectations for completion of |
| | the task to employees. |
| 3 | Provide adequate instructions and guidance to employees |
| | to ensure delegated tasks are completed in a timely |
| | manner and meet stated objectives. |
| 3 | Assign an appropriate level of authority/accountability |
| | to the employees when delegating tasks. |
| 4 | Develop and implement follow-up systems to ensure work |
| | is completed properly and on time. |
| 3, 5, 6 | Be available, accessible, and open to answering questions |
| | and providing clarification to the employees. |

TABLE 12
Competency Area: Team Management
Competency: Giving/Receiving Feedback
Objective
Demonstrate ability to provide positive and developmental feedback to
others on a regular basis and to receive feedback from others.
Learning Outcomes

| | Knowledge Component: to demonstrate competence in this |
|---|---|
| K No. | area, a PM will be able to do the following: |
| 1 | Explain the importance of properly formulating feedback. |
| 2 | Describe why one should relate positive and developmental |
| | feedback to employees in a timely manner. |
| 3 | Define effective communication techniques that are used |
| | to provide developmental feedback with individuals |
| | and groups. |
| 4 | Describe techniques to use for receiving developmental |
| | feedback in a nondefensive manner. |
| 5 | Understand when and where to give developmental |
| | feedback, including the importance of ongoing |
| | follow-up. |
| Applicable | Skill Component: to demonstrate competence in this area, |
| K Nos. | a PM will do the following: |
| 1-3 | Provide specific, timely feedback, positive and |
| | developmental as appropriate, to project team |
| | members. |
| 4 | Receive feedback openly and with a positive attitude |
| | toward changing behavior. |
| 4 | Be receptive to candid feedback and take action to |
| | implement improvements. |
| 3 | Describe techniques for observing employees and |
| | gathering performance data that is as accurate, |
| | objective, and unbiased as possible. |
| 5 | Provide examples of specific behaviors to |
| | support feedback. |

TABLE 13
Competency Area: Team Management
Competency: Team Building/Management
Objective
Demonstrate ability to form, develop, and manage the team to
meet the stakeholder's expectations and objectives.
Learning Outcomes

| | Knowledge Component: to demonstrate competence in this |
|---|---|
| K No. | area, a PM will be able to do the following: |
| 1 | Differentiate between a team and a group. |
| 2 | Describe the phases of team development and |
| | their characteristics. |
| 3 | Explain the stages of the team development process. |
| 4 | Explain various team decision-making processes and their |
| | appropriate uses. |
| 5 | Define the role of the leader in building and managing |
| | the team. |
| 6 | Relate the importance of defining team member roles and |
| | responsibilities by providing examples illustrating the |
| | impact of when this did and did not occur. |
| 7 | Describe the benefits that can be achieved by aligning |
| | team member roles and responsibilties to optimize the |
| | diverse strengths of the team. |
| 8 | Explain how to sustain the team. |
| Applicable | Skill Component: to demonstrate competence in this area, |
| K Nos. | a PM will do the following: |
| 4-5 | Manage the team to operate in accordance with the |
| | guidelines and processes documented in the |
| | endorsed project charter and workplan. |
| 1-8 | Guide, enable, coach, and monitor individual and team |
| | activities to achieve established goals and objectives. |
| 5, 8 | Facilitate team self-assessment to identify lessons learned. |
| 1-8 | Facilitate modification of the team's people/process/tools/ |
| | structure to incorporate corrective actions targeted at |
| | improved performance. |

TABLE 14
Competency Area: Interpersonal Skills and Communication
Competency: Oral Communication
Objective
Demonstrate ability to convey information
through speaking and oral presentations.
Learning Outcomes

| | Knowledge Component: to demonstrate competence in this |
|---|---|
| K No. | area, a PM will be able to do the following: |
| 1 | Mentally compose and organize messages before |
| | delivering them. |
| 2 | Describe the purpose of presentations. |
| 3 | Explain how to recognize different types of audiences. |
| 4 | Define effective communication and presentation skills. |
| | Provide examples to illustrate when different forms of |
| | oral communication may be appropriate. |
| 5 | Describe the parts of a presentation. |
| 6 | Describe techniques, methods, and tools used to enhance |
| | oral communications, including presentations. |
| 7 | Describe the process to prepare for oral communications, |
| | including presentations. |
| 8 | Describe the process to evaluate oral communications, |
| | including presentations. |
| Applicable | Skill Component: to demonstrate competence in this area, |
| K Nos. | a PM will do the following: |
| 1 | Convey messages to others in a manner that is organized |
| | logically, completely, and coherently. |
| 2, 3, 7 | Plan a presentation by considering the intended purpose |
| | and audience, at a minimum. |
| 4-8 | Organize the content of a presentation to include an |
| | appropriate introduction, body, discussion, and |
| | conclusion. |
| 6 | Incorporate illustrations and other nonwritten information |
| | as appropriate in a presentation. |
| 4 | Communicate clearly and concisely. |
| 4 | Demonstrate how to respond to audience questions. |
| 8 | Seek feedback on the presentation, its delivery, and the |
| | communication of the intended message(s). |

TABLE 15
Competency Area: Interpersonal Skills and Communication
Competency: Written Communication
Objective
Demonstrate ability to present ideas and information
in a variety of written communication formats.
Learning Outcomes

| | Knowledge Component: to demonstrate competence in this |
|---|---|
| K No. | area, a PM will be able to do the following: |
| 1 | Describe techniques used to write clearly and concisely. |
| 2 | Understand and use the basic rules of grammar, sentence |
| | structure, spelling, and punctuation. |
| 3 | Explain the importance of tailoring communication for the |
| | intended audience. |
| 4 | Relate the importance of written documentation in our |
| | work by providing examples of when the lack of |
| | documentation adversely affected the achievement of our |
| | objectives and when the presence of documentation |
| | helped us achieve our objectives |
| 5 | Arrange content of written communications in a logical |
| | order to promote reader understanding and comprehension. |
| 6 | Understand the role and use of available support |
| | resources (including editors, graphic artists, |
| | etc.) and tools that can be applied to convey the |
| | intended message. |
| 7 | Explain the activities in the writing process. |
| 8 | Apply appropriate formats for written messages. |
| Applicable | Skill Component: to demonstrate competence in this area, |
| K Nos. | a PM will do the following: |
| 1, 4 | Plan communications by considering the intended purpose |
| | and audience, at a minimum. |
| 2 | Apply the key elements of the writing process. |
| 3-5 | Choose the appropriate format for written messages |
| | (emails, memos, reports, letters). |
| 5 | Write at the level of the intended audience. |
| 5, 8 | Incorporate figures, tables, and other nontext information |
| | to enhance communication of the intended message. |

TABLE 16
Competency Area: Interpersonal Skills and Communication
Competency: Effective Listening
Objective
Demonstrate ability to listen to understand rather than to respond.
Learning Outcomes

| | Knowledge Component: to demonstrate competence in this |
|---|---|
| K No. | area, a PM will be able to do the following: |
| 1 | Identify specific techniques to use that help improve one's |
| | listening skills. |
| 2 | Identify his or her own good and poor listening habits |
| | or tendencies. |
| 3 | Describe nonverbal behaviors related to listening. |
| 4 | Explain how to clarify potential misunderstandings. |
| Applicable | Skill Component: to demonstrate competence in this area, |
| K Nos. | a PM will do the following: |
| 1, 3 | Employ effective listening techniques to demonstrate active |
| | listening as a top priority during conversations |
| | with others. |
| 2-5 | Apply effective listening techniques to |
| | improve understanding. |
| 1-5 | Ask for feedback from the speaker about one's |
| | listening skills. |
| 4 | Recap the speaker's message and check to see that the |
| | intended message was received and |
| | understood. |
| 4 | Allow speakers adequate time to communicate their |
| | message and minimize interruptions. |

TABLE 17
Competency Area: Interpersonal Skills and Communication
Competency: Meeting Management
Objective
Demonstrate ability to plan and conduct
meetings to achieve stated objectives.
Learning Outcomes

| | Knowledge Component: to demonstrate competence in this |
|---|---|
| K No. | area, a PM will be able to do the following: |
| 1 | Explain the purpose of and describe when to conduct |
| | various types of meetings. |
| 2 | Describe techniques used to plan and conduct |
| | effective meetings. |
| 3 | Explain how to choose the meeting attendees. |
| 4 | Explain the importance of defining the roles of all |
| | meeting participants. |
| 5 | Describe how and when to use meeting management/ |
| | facilitation skills. |
| 6 | Describe methods used to achieve consensus in meetings. |
| 7 | Describe follow-up methods to use to ensure action items |
| | are resolved after meetings. |
| Applicable | Skill Component: to demonstrate competence |
| K Nos. | in this area, a PM will do the following: |
| 1-4 | Prepare a concise, well-defined meeting agenda. |
| 2 | Communicate an agenda and pre-meeting preparation |
| | requirements to the team. |
| 2, | Facilitate meeting activities/discussion to achieve stated |
| 5-6 | meeting objectives. |
| 5-6 | Compile action items, if any, and assign a responsible |
| | party and due date to each. |
| 7 | Follow-up with those responsible for completion of action |
| | items to reach closure. |
| 2 | Follow-up with meeting participants to assess the |
| | effectiveness of the meeting. |

TABLE 18
Competency Area: Interpersonal Skills and Communication
Competency: Conflict Management
Objective
Demonstrate ability to identify potential or real
conflict and implement resolution strategies.
Learning Outcomes

| | Knowledge Component: to demonstrate competence in this |
|---|---|
| K No. | area, a PM will be able to do the following: |
| 1 | Define one's own conflict triggers. |
| 2 | Explain how different individuals may respond to conflict. |
| | Provide an example of how one's central |
| | tendencies affect response to conflict. |
| 3 | Describe the need to take a proactive approach in dealing |
| | with conflict situations by providing an example of how |
| | taking such an approach could have minimized or |
| | eliminated a conflict. |
| 4 | Explain how to identify potential conflicts. |
| 5 | Define a range of strategies and methods/approaches for |
| | dealing with conflict. Describe a situation/ |
| | circumstance when each may be used. |
| Applicable | Skill Component: to demonstrate competence in this area, |
| K Nos. | a PM will do the following: |
| 1 | Identify ways to improve one's conflict management style. |
| 4 | Identify and address potential conflict issues/situations. |
| 2, 3, 5 | Employ appropriate strategies and methods/approaches to |
| | resolve conflict situations. |

TABLE 19
Competency Area: Leadership
Competency: Project Leadership
Objective
Demonstrate ability to guide the project team to establish and
achieve its vision, strategy, goals, objectives, and metrics.
Learning Outcomes

| | Knowledge Component: to demonstrate competence in this |
|---|---|
| K No. | area, a PM will be able to do the following: |
| 1 | Define leadership and management. |
| 2 | Recognize and explain the differences between leadership |
| | and management. Provide an example that relates the |
| | importance of balancing leadership and management over |
| | the course of managing a project. |
| 3 | Describe different leadership styles and explain when |
| | it is appropriate to apply each. |
| Applicable | Skill Component: to demonstrate competence in this area, |
| K Nos. | a PM will do the following: |
| 1 | Facilitate actions leading to the development, endorsement, |
| | and achievement of the team's vision, strategy, goals, |
| | objectives, and metrics. |
| 1 | Proactively identify and remove obstacles to the |
| | team's success. |
| 1 | Demonstrate the skills, behaviors, and techniques to guide |
| | and develop the team. |
| 1-2 | Lead by example. Demonstrate the behaviors that empower |
| | action in others. |
| 1 | Communicate effectively within the team, with the client, |
| | and other external stakeholders, as well as |
| | with management. |
| 3 | Apply the appropriate leadership style for a |
| | given situation. |

TABLE 20
Competency Area: Leadership
Competency: Coach and Develop Others
Objective
Demonstrate ability to support and guide
another's efforts to develop him/herself.
Learning Outcomes

| | Knowledge Component: to demonstrate competence in this |
|---|---|
| K No. | area, a PM will be able to do the following: |
| 1 | Describe the fundamental skills involved in coaching and |
| | mentoring others. |
| 2 | Describe different methods that can be employed to |
| | develop staff. Provide examples of each. |
| 3 | Explain CH2M HILL processes used to support development |
| | of our people. |
| 4 | Identify the resources and tools available to assist with |
| | coaching others. |
| Applicable | Skill Component: to demonstrate competence in this area, |
| K Nos. | a PM will do the following: |
| 1-4 | Conduct a performance discussion with the individual and |
| | agree upon expectations and standards of performance. |
| 1-4 | Discuss potential growth opportunities with the individual. |
| | Mutually agree on key targeted opportunities. Facilitate |
| | actions to help the individual to achieve the target. |
| 1 | Use and practice coaching skills by making time to |
| | observe each individual's work performance on a |
| | regular basis. |
| 1 | Demonstrate leadership by making time to actively listen |
| | to each individual's concerns, ideas, challenges, etc. |
| 1-3 | Engage individuals in reflective discussion about their |
| | performance on a regular basis. |
| 1-3 | Provide specific, timely performance feedback to |
| | individuals on a regular basis. |
| 1-4 | Apply developmental methods appropriate to each |
| | individual's needs/abilities and the specific work |
| | situation. |
| 1-3 | Coach, guide, and mentor individual team members. |

TABLE 21
Competency Area: Client Service Management
Competency: Client Service Management
Objective
Demonstrate ability to develop and implement
a client service management plan.
Learning Outcomes

| | Knowledge Component: to demonstrate competence in this |
|---|---|
| K No. | area, a PM will be able to do the following: |
| 1 | Explain the full spectrum of client service. |
| 2 | Describe what a client service plan is, why it is important, |
| | and list the benefits to the client and to the project team. |
| 3 | Describe the elements of a client service plan. |
| 4 | Describe the techniques used to develop a client |
| | service plan. |
| 5 | Describe various methods for communicating the client |
| | service plan to the team. |
| 6 | Explain the importance of monitoring team performance in |
| | respect to the plan throughout the project, including |
| | through project closeout. |
| 7 | Explain how to deliver bad news to the client and why it |
| | is important to do so in a timely manner. |
| 8 | Recognize the importance of etablishing trusted |
| | relationships with key client decision-makers. Identify |
| | methods/approaches that can be used to develop |
| | such relationships. |
| 9 | Explain the importance of understanding our |
| | client's business. |
| 10 | Describe the importance of understanding our client |
| | contact's role in his/her business. Identify methods/ |
| | approaches that can be used to achieve a |
| | deeper understanding. |
| Applicable | Skill Component: to demonstrate competence in this area, |
| K Nos. | a PM will do the following: |
| 1-4, | Develop a project client service plan. |
| 8-10 | |
| 5-7 | Execute the plan during the project. |
| 6 | Assess the effectiveness of the plan throughout |
| | the project. |

TABLE 22
Competency Area: Client Service Management
Competency: Becoming a Preferred Provider
Objective
Demonstrate ability to anticipate additional
client needs and construct solution scenarios.
Learning Outcomes

| | Knowledge Component: to demonstrate competence in this |
|---|---|
| K No. | area, a PM will be able to do the following: |
| 1 | Review the full range of services offered by CH2M HILL |
| 2 | Describe how to use change to provide additional services. |
| 3 | Define the Mandeville technique and describe its application |
| | as a tool to understanding the client's unmet needs. |
| 4 | Recognize the importance of establishing trusted |
| | relationships with key client decision-makers. |
| 5 | Describe the importance of understanding our |
| | client's business. |
| 6 | Describe the importance of understanding our client |
| | contact's role in his/her business. Identify |
| | methods/approaches that can be used to achieve a |
| | deeper understanding. |
| 7 | Recognize the importance of understanding our client's |
| | preferred provider network and CH2M HILL's role in it. |
| 8 | Recognize the importance of understanding how |
| | partnerships/alliances are formed and maintained. |
| Applicable | Skill Component: to demonstrate competence in this area, |
| K Nos. | a PM will do the following: |
| 1-8 | Identify potential areas of additional need at the outset of |
| | the project. |
| 1-8 | Revise the list of potential needs throughout the project. |
| 7 | Identify and pursue, as appropriate, methods/approaches |
| | that can be used to enhance our position/status in the |
| | client's preferred provider network. |
| 8 | Identify and pursue, as appropriate, potential opportunities |
| | for partnerships/alliances to enhance the delivery of |
| | services to our client. |
| 2, 5, | Work with the CSM to evaluate additional service |
| 7-8 | opportunities and present to the client as |
| | appropriate. |

TABLE 23
Competency Area: Project Planning & Controls
Competency: Scope Development
Objective
Demonstrate ability to construct a clear, feasible, attainable definition
of the work to be performed that meets the client's and
CH2M HILL'S requirements.
Learning Outcomes

| | Knowledge Component: to demonstrate competence in this |
|---|---|
| K No. | area, a PM will be able to do the following: |
| 1 | Relate the importance of having a defined project vision, |
| | objectives, and critical success factors and describe |
| | the process for defining these elements. |
| 2 | Identify and describe the essential and optional elements |
| | of a project scope. |
| 3 | Define work breakdown structure, discuss its importance to |
| | the project (including when it should be developed), and |
| | describe techniques for developing the WBS. |
| 4 | Describe methods for dealing with a client-specified WBS |
| | versus how we will manage the project. |
| 5 | Define the meaning of “specific,” “clear,” “feasible,” and |
| | “attainable” as each relates to scope preparation. |
| 6 | Describe how the project scope serves as a key link to |
| | other contract sections (e.g., term/conditions, |
| | compensation, change management). |
| 7 | Relate how the project scope links to project controls and |
| | cost/pricing elements and activities. |
| 8 | Discuss the guidelines for writing a scope document. |
| Applicable | Skill Component: to demonstrate competence in this area, |
| K Nos. | a PM will do the following: |
| 1 | Develop the vision, objectives, and critical success factors |
| | at a minimum for the project. |
| 2-5, | Prepare the work breakdown structure (WBS task list). |
| 7-8 | |
| 1-8 | Write specific, clear, feasible, measurable, and attainable |
| | task descriptions for WBS tasks, including preparation of |
| | the list of contract deliverables, and compile these |
| | elements to form the scope. |

TABLE 24
Competency Area: Project Planning and Controls
Competency: Work Planning
Objective
Demonstrate ability to prepare a project work
plan that meets CH2M HILL's requirements.
Learning Outcomes

| | Knowledge Component: to demonstrate competence in this |
|---|---|
| K No. | area, a PM will be able to do the following: |
| 1 | Define what a work plan is and explain why every project |
| | needs one. |
| 2 | Identify and describe the essential and optional elements |
| | of a work plan. |
| Applicable | Skill Component: to demonstrate competence in this area, |
| K Nos. | a PM will do the following: |
| 1-7 | Lead the team's activities to develop a project work plan |
| | to match project needs. |
| 1, 2 | Communicate the project work plan to all project |
| | team members. |
| 1 | Document the project work plan as part of the project file. |
| 1, 2 | Implement the work plan. |
| 1, 2 | Update the work plan as appropriate to reflect changes |
| | to the project. |

TABLE 25
Competency Area: Project Planning and Controls
Competency: Project Baselining
Objective
Demonstrate ability to construct and maintain
the schedule/cost baseline for the project.
Learning Outcomes

| | Knowledge Component: to demonstrate competence in this |
|---|---|
| K No. | area, a PM will be able to do the following: |
| 1 | Define key terms, including “project baseline,” “estimate at |
| | complete (EAC),” “estimate to complete (ETC),” |
| | “technical percent complete,” “variance at completion |
| | (VAC),” “earned value,” “cost performance index,” |
| | and “schedule performance index.” |
| 2 | Describe CH2M HILL's project controls process, including |
| | identification of key resources and tools available to |
| | assist PMs in applying project controls on projects. |
| 3 | Relate how the WBS links to the cost/schedule baselines. |
| 4 | Describe the importance of establishing the schedule |
| | baseline and the methods/approaches that can be used |
| | to develop it. |
| 5 | Describe the importance of establishing the cost baseline |
| | and the methods/approaches that can be used to develop it. |
| 6 | Discuss how the cost/schedule baselines relate to change |
| | management. Provide an example of when a cost/schedule |
| | baseline was used to help a PM identify and |
| | negotiate a change. |
| 7 | Describe how the cost/schedule baseline relates to the |
| | cost/pricing process. |
| 8 | Provide examples of how the project controls group can be |
| | accessed and used to facilitate preparation of the |
| | project's cost/schedule baseline. |
| Applicable | Skill Component: to demonstrate competence in this area, |
| K Nos. | a PM will do the following: |
| 1-9 | Follow CH2M HILL's project controls process. |
| 2-3, | Use appropriate project controls resources and tools to |
| 5-6, | construct the cost/schedule baseline. |
| 9 | |
| 1-2, | Develop and document the project cost/schedule baseline. |
| 5-6 | |

TABLE 26
Competency Area: Project Planning and Controls
Competency: Monitoring and Control
Objective
Demonstrate ability to monitor project performance against the
established baseline to identify and implement corrective
and/or optimization actions.
Learning Outcomes

| | Knowledge Component: to demonstrate competence in this |
|---|---|
| K No. | area, a PM will be able to do the following: |
| 1 | Discuss the importance of maintaining the project baseline |
| | and describe the process used to update the baseline when |
| | needed during the project. |
| 2 | Describe the importance and process used to regularly |
| | update project status. Discuss who participates in this |
| | process, including the role and contribution of each |
| | team member. |
| 3 | Review the range of earned value calculation methods and |
| | list the pros and cons of each. |
| 4 | Describe how project controls information can be used to |
| | improve project delivery performance. |
| 5 | Describe the relationship of cost/schedule baselines to |
| | identification of changes and the implementation of the |
| | project's change management process. |
| 6 | Provide examples of common cost/schedule issues, the |
| | potential causes of each, and identify possible |
| | corrective actions. |
| Applicable | Skill Component: to demonstrate competence in this area, |
| K Nos. | a PM will do the following: |
| 1 | Maintain the project cost/schedule baseline in accordance |
| | with contractual approvals. |
| 2-6 | Update project status on a consistent schedule appropriate |
| | for the project. |
| 3-4 | Review project controls data to identify potential and |
| | actual cost/schedule issues. |
| 4-6 | Implement appropriate corrective/optimization actions to |
| | achieve agreed-upon cost/schedule commitments. |

TABLE 27
Competency Area: Project Planning and Controls
Competency: Managing Project Information
Objective
Demonstrate ability to manage project information from
receipt of the request for proposal through project closeout.
Learning Outcomes

| | Knowledge Component: to demonstrate competence In this |
|---|---|
| K No. | area, a PM will be able to do the following: |
| 1 | Relate the importance of project documentation in our work |
| | by providing examples of when the lack of documentation |
| | adversely impacted the achievement of our objectives and |
| | when the presence of documentation helped us achieve |
| | our objectives. |
| 2 | Discuss CH2M HILL's records retention policy as it relates |
| | to project information. |
| 3 | Identify what information needs to be managed. |
| 4 | Identify and classify what information needs to be included |
| | as part of the final project file. |
| 5 | Describe available methods and tools for managing |
| | electronic files. |
| 6 | Describe available methods and tools for managing hard |
| | copy information. |
| 7 | Provide examples of how support resources can be used to |
| | assist the PM and team in managing project information. |
| Applicable | Skill Component: to demonstrate competence in this area, |
| K Nos. | a PM will do the following: |
| 1-7 | Develop a project information management plan that meets |
| | both the project's contractual requirements and |
| | CH2M HILL's requirements. |
| 5-7 | Use appropriate processes and tools to facilitate information |
| | storage and retrieval during and following completion of |
| | the project. |
| 1-7 | Implement the plan. |
| 1-7 | Compile all project information, purge extraneous materials, |
| | and construct the project file for final storage at the |
| | conclusion of the project. |
| 1 | Assess the effectiveness of the plan and the team's |
| | activities to follow the plan. |

TABLE 28
Competency Area: Financial Management
Competency: Cost and Pricing
Objective
Demonstrate ability to apply
CH2M HILL's cost and pricing process
Learning Outcomes

| | Knowledge Component: to demonstrate competence in |
|---|---|
| K No. | this area, a PM will be able to do the following: |
| 1 | Define key terms, including “cost” (all types & |
| | categories), “price,” “gross and net |
| | margin” (gross/net), and “revenue” (all |
| | categories) and describe the relationship of |
| | each term to the other terms in the context |
| | of project financial management. |
| 2 | Explain the differences between the firm's Arthur |
| | Andersen-audited overhead rate, our fully loaded |
| | rate, our federally compliant rate, and our |
| | forward pricing rate agreement. Identify the |
| | applicability of each. |
| 3 | Explain the purpose and information contained in the |
| | firm's CAS disclosure statements. |
| 4 | Explain the differences between the firm's commercial |
| | and federal service center rates. Identify the |
| | applicability of each. |
| 5 | Describe the rate structures used by our affiliate |
| | companies and the transfer pricing rates used |
| | between INC and each affiliate entity. |
| 6 | Relate the effect multiple currencies can have on costs |
| | and pricing a project. |
| 7 | Relate the similarities and differences experienced |
| | when following CH2M HILL's cost/pricing process |
| | under federal versus commercial |
| | contracting requirements. |
| 8 | Discuss the elements of developing a “good” cost and |
| | negotiating a “good” price on a project. |
| 9 | Explain how the firm makes money by describing the |
| | basic financial operating model of the firm. |
| | Provide an example of how retainage adversely |
| | impacts the firm's cash flow. |
| 10 | Describe CH2M HILL's cost/pricing process by |
| | relating how it is to be applied on a new |
| | project. Identify the resources and tools |
| | available to assist in completing |
| | this process. |
| 11 | List the firm-endorsed tools available to support the |
| | cost/pricing process and describe the purpose of each. |
| 12 | Describe the relationship of a project's cost and price |
| | to the potential financial outcomes that may result |
| | from the project. |
| 13 | Discuss the key factors to be considered when |
| | presenting cost and price information to the client. |
| 14 | Describe the process to be followed and approvals |
| | required for endorsing cost/pricing information in |
| | response to a request for proposal and |
| | contract modification. |
| Applicable | Skill Component: to demonstrate competence in this |
| K Nos. | area, a PM will do the following: |
| 7-14 | Follow CH2M HILL's cost/pricing process. |
| 10-11 | Use a firm-endorsed cost/pricing tool to develop the |
| | cost estimate and proposed price. |
| 1-14 | Develop and document the basis of estimate for all |
| | cost and pricing elements. |

TABLE 29
Competency Area: Financial Management
Competency: Managing Project Finances
Objective
Demonstrate ability to manage project finances from
project setup through project financial closeout.
Learning Outcomes

| | Knowledge Component: to demonstrate competence in this |
|---|---|
| K No. | area, a PM will be able to do the following: |
| 1 | Define key terms, including “cost” (all types & categories), |
| | “gross and net margin” (gross/net), “revenue” (all |
| | categories), “project investment” (all components), “Net |
| | Asset Charge (MAC),” and “EAC and ETC” and describe |
| | the relationship of each term. |
| 2 | Describe the purpose of Oracle as it relates to project |
| | financial management. Describe how the data in Oracle |
| | relates to the data shown via Project Insight/SNAPSHOT. |
| 3 | For each type of financial data, discuss when and why it |
| | is essential to review and maintain the accuracy of the |
| | financial data on one's project. |
| 4 | Describe the key project financial management processes |
| | and explain the relationship of each process to the |
| | others. Identify key resources and tools that can assist |
| | a PM in completing these processes. |
| 5 | Explain the purpose and components the key project |
| | financial metrics used to measure individual |
| | project financial performance. |
| 6 | Based on the type of project being managed, identify |
| | specific actions that can be taken to optimize/ |
| | improve the project's financial outcomes. |
| 7 | Relate each element of the project's financial performance |
| | to the resulting impacts on the firm's financial |
| | performance, including recognition of New Business In and |
| | Labor New Business In. |
| 8 | Explain the purpose and value of providing accurate input |
| | to the firm's quarterly revenue forecasting process. |
| | Provide examples of methods for developing input values |
| | for one's project |
| Applicable | Skill Component: to demonstrate competence in this area, |
| K Nos. | a PM will do the following: |
| 1-8 | Follow the established project setup, monthly statusing, |
| | invoicing/collections, and financial closeout processes. |
| 2, 4 | Use appropriate tools in support of setup, statusing, |
| | invoicing/collections, and financial closeout processes. |
| 2-4 | Obtain needed project financial data from the Oracle system. |
| 8 | Provide timely, accurate revenue forecasting data upon |
| | request from the PDM. |

TABLE 30
Competency Area: Change Management
Competency: Project Change Management
Objective
Demonstrate ability to identify potential/real changes and
implement management, mitigation, and/or optimization actions.
Learning Outcomes

| | Knowledge Component: to demonstrate competence in this |
|---|---|
| K No. | area, a PM will be able to do the following: |
| 1 | Define change management and describe why it is an |
| | essential part of our PD process. |
| 2 | Define when change management begins and ends on a |
| | project. Identify different types of change, |
| | including third party changes that may impact our |
| | project baseline, and provide an example of each. |
| 3 | Describe the content of each essential element of a change |
| | management plan. |
| 4 | Explain the process to develop and implement a change |
| | management plan on a new project. |
| 6 | Describe how to recognize a change on a project by relating |
| | a recent project example. |
| 7 | Describe the elements and timing for change |
| | management reporting. |
| 8 | Identify specific change management actions that can be |
| | considered and provide examples of each. |
| Applicable | Skill Component: to demonstrate competence in this area, |
| K Nos. | a PM will do the following: |
| 1-5 | Build a change management plan for the project. |
| 4 | Document the plan, distribute it to the team, and include it |
| | in the project file. |
| 4-7 | Implement the change management plan. |
| 6 | Complete change management reporting requirements in |
| | accordance with specified schedules. |
| 1-2 | Assess the team's change management activities at regular |
| | intervals throughout the project, including a final |
| | assessment during project closeout. |

TABLE 31
Competency Area: Risk Management
Competency: Project Risk Management
Objective
Demonstrate ability to identify potential/real risks and
implement management, mitigation, and/or optimization actions.
Learning Outcomes

| | Knowledge Component: to demonstrate competence in this |
|---|---|
| K No. | area, a PM will be able to do the following: |
| 1 | Define risk management and describe why it is an |
| | essential part of project management. |
| 2 | Define when risk management begins and ends on a |
| | project. Identify key CH2M HILL policies that |
| | serve as part of the foundation for the firm's |
| | risk management activities. |
| 3 | Describe the content of each essential element of a risk |
| | management plan. |
| 4 | Explain the process to develop and implement a risk |
| | management plan on a new project. Identify key |
| | resources and tools available to assist a PM in the |
| | preparation of such a plan. |
| 5 | Identify the purpose and criteria for application of CCI's |
| | Opportunity Risk Evaluation process. |
| 6 | Describe the elements and timing for risk |
| | management reporting. |
| 7 | Identify possible risk management actions and provide |
| | examples of each. |
| Applicable | Skill Component: to demonstrate competence in this area, |
| K Nos. | a PM will do the following: |
| 1-5 | Build a risk management plan for the project. |
| 4 | Document the plan, distribute it to the team, and include |
| | it in the project file. |
| 2-5 | Update the plan as needed to reflect changing |
| | project risks. |
| 4-7 | Implement the risk management plan. |
| 6-7 | Complete the risk management reporting requirements in |
| | accordance with stated schedules. |
| 1-2 | Assess the team's risk management activities throughout |
| | the project performance period. |

TABLE 32
Competency Area: Contract/Subcontract Management
Competency: Contract Development
Objective
Demonstrate ability to develop a sound contract by applying
CH2M HILL's contract/signature authority policy.
Learning Outcomes

| | Knowledge Component: to demonstrate competence in this |
|---|---|
| K No. | area, a PM will be able to do the following: |
| 1 | Define what is meant by a “binding contract” and what |
| | constitutes a “contract” or “offer.” |
| 2 | Describe the purpose and content of CH2M HILL's |
| | Contract & Signature Authority policy and how one |
| | should apply the policy to help craft a |
| | “good” contract. |
| 3 | Describe the purpose of each type of CH2M HILL Standard |
| | Form contract. |
| 4 | Explain the primary benefits and when each of the |
| | following forms of agreement can/should be used: |
| | Cost Plus (fixed fee, award fee, incentive fee) |
| | Time and Materials |
| | Lump Sum or Fixed Price |
| | Percentage of Construction |
| | Master Services Agreements. |
| 5 | Relate the importance of understanding the correct legal |
| | entity for the stated scope and following the |
| | Contract & Signature Authority policy by providing |
| | examples of what can occur if one does not comply. |
| 6 | Describe when, how, and the importance of translating the |
| | contents of what the contract says into related workplan |
| | elements and project documentation. |
| 7 | Identify the circumstances requiring the application of the |
| | Inter-company Work Exchange Agreement. |
| 8 | Describe the KA organization, including its purpose, |
| | structure, and primary resources available to support |
| | project delivery. |
| 9 | Identify specific CH2M HILL policies that define scopes of |
| | work that the firm will not accept and relate the primary |
| | rationale for each. |
| 10 | Define conflict of interest, identify the most common forms, |
| | and describe the process one should use to determine |
| | whether an actual conflict exists. |
| 11 | Discuss procurement integrity as it relates to Federal |
| | procurements. Identify what it is, why it is important, |
| | and who should be notified if one believes there is a |
| | potential procurement integrity issue. |
| 12 | Relate the impact currency and tax issues can have on the |
| | development and execution of a contract. |
| Applicable | Skill Component: to demonstrate competence in this area, |
| K Nos. | a PM will do the following: |
| 1-12 | Follow CH2M HILL's contract development/review process. |
| 6 | Prepare a schedule of contract deliverables as part of the |
| | contract development process. |
| 6 | Include the completed contract review form in the |
| | project file. |

TABLE 33
Competency Area: Contract/Subcontract Management
Competency: Contract Management
Objective
Demonstrate ability to comply with the contract terms, conditions,
and requirements throughout the period of performance.
Learning Outcomes

| | Knowledge Component: to demonstrate competence in this |
|---|---|
| K No. | area, a PM will be able to do the following: |
| 1 | Describe the purpose, content, and timing for preparation |
| | of a contract brief and identify who should be the |
| | primary developer(s) of such a document. |
| 2 | Describe common contract compliance items by providing |
| | examples of each from a current contract. |
| 3 | Identify categories of “special” compliance issues that may |
| | be found in a client's contract. |
| 4 | Understand how to recognize, plan for, and implement |
| | actions to optimize CH2M HILL's performance under |
| | the contract. Provide examples of specific actions |
| | that can be taken and who could benefit from each. |
| 5 | Describe the purpose, timing, requirements, and process |
| | to follow to closeout a contract. |
| 6 | Discuss the ramifications of noncompliance with the |
| | contract to the project and to the firm. |
| Applicable | Skill Component: to demonstrate competence in this area, |
| K Nos. | a PM will do the following: |
| 1-3 | Facilitate preparation of the contract brief. |
| 1 | Document the contract brief by including it in the project |
| | work plan. |
| 1-6 | Assess the ongoing activities of the project and manage |
| | the team's activities to comply with all |
| | contract requirements. |
| 4 | Follow the contract closeout process. |
| 4, 6 | Assess the team's contract management activities at |
| | regular intervals throughout the project, including |
| | a final assessment during project closeout. |

TABLE 34
Competency Area: Contract/Subcontract Management
Competency: Procurement Management
Objective
Demonstrate ability to plan, contract, oversee,
and closeout subcontractor/vendor work.
Learning Outcomes

| | Knowledge Component: to demonstrate competence in this |
|---|---|
| K No. | area, a PM will be able to do the following: |
| 1 | Describe the purpose, scope, and application of |
| | CH2M HILL's procurement process. |
| 2 | Discuss the criteria that specify when a subcontract/ |
| | purchase order is required. |
| 3 | Describe the purpose and application of each type of |
| | subcontract agreement. |
| 4 | Explain the importance of using the appropriate |
| | subcontract form based on the definition of the |
| | project need. |
| 5 | Explain the purpose and importance of obtaining |
| | certificates of insurance/bonding from each |
| | subcontractor/vendor. |
| 6 | Define what is meant by a “flowdown clause” and identify |
| | the clauses most commonly flowed from one level |
| | of contract to the next. |
| 7 | Discuss the purpose and importance of using |
| | purchase requisitions. |
| 8 | Identify the list of firm-endorsed procurement tools, |
| | including the purpose of and how to access each. |
| 9 | Discuss the purpose and importance of clearly stating the |
| | health, safety, and environmental requirements of the |
| | subcontractor/vendor in the RFP or during the |
| | selection process. |
| 10 | Discuss the criteria used to determine subcontractor/ |
| | vendor sourcing and competition requirements, |
| | including consideration of small- and minority- |
| | business enterprise requirements. |
| 11 | Explain the impact subcontractor/vendor quality, |
| | performance, and safety ratings can have on |
| | our business. |
| 12 | Describe the subcontractor/vendor statement of work |
| | development and deliverable review processes, |
| | including key timing issues. Identify who should |
| | be involved in each of these processes. |
| 13 | Describe the subcontractor/vendor invoice review and |
| | approval process, including key timing issues. |
| | Identify who should be involved in the process. |
| 14 | Describe the subcontract closeout process, including key |
| | timing issues. Identify who should be involved in |
| | the process. |
| 15 | Explain the impact that subcontractor/vendor payment |
| | terms, including the use of retention, can have on |
| | the project's and CH2M HILL's financial performance. |
| Applicable | Skill Component: to demonstrate competence in this area, |
| K Nos. | a PM will do the following: |
| 1-15 | Prepare the subcontractor/vendor procurement plan and |
| | include as part of the project work plan. |
| 1 | Follow CH2M HILL's procurement process. |
| 9-11 | Include the completed subcontractor health and safety |
| | questionnaire in the project file. |
| 5 | Include the current insurance certificates/bonds in the |
| | project file. |
| 12 | Include copies of all final subcontract deliverables in the |
| | project file. |
| 14 | Follow the subcontract closeout process. |
| 14 | Include all required closeout documentation in the |
| | project file. |

TABLE 35
Competency Area: Contract/Subcontract Management
Competency: Negotiation
Objective
Demonstrate ability to plan and implement negotiation strategies.
Learning Outcomes

| | Knowledge Component: to demonstrate competence in this |
|---|---|
| K No. | area, a PM will be able to do the following: |
| 1 | Describe the steps of the negotiation process. Identify |
| | who should participate in the process on behalf |
| | of CH2M HILL. |
| 2 | Discuss the importance and scope of thorough preparation |
| | for negotiations. |
| 3 | Relate the importance and key impacts of the human |
| | element in negotiations. |
| 4 | Discuss key negotiation concepts (e.g., BATNA, Trip Wires, |
| | Walk Away Position/Bottom Line) by providing examples |
| | of each. |
| 5 | Identify resources and tools that can be used to support |
| | the negotiation process, including the purpose and |
| | use of each. |
| Applicable | Skill Component: to demonstrate competence in this area, |
| K Nos. | a PM will do the following: |
| 1-5 | Develop a negotiation plan, which includes the team's key |
| | strategies, going in position, and desired outcome. |
| 1-2, | Implement the plan. |
| 5 | |
| 1-4 | Adjust strategies and methods/approaches as needed |
| | during negotiations to achieve the desired outcome. |
| 1 | Assess the team's negotiation activities. |

One skilled in the art will appreciate that although specific embodiments of the career development framework have been described herein for purposes of illustration, various modifications may be made without deviating from the spirit and scope of the invention. Accordingly, the invention is not limited, except by the appended claims.

1. A method for business career development, comprising:
defining relevant competencies for a business career, each competency having requirements to be satisfied for that competency to be attained;
periodically identifying one or more competencies to be attained by a student during a period;
for each identified competency,
selecting a coach to assist the student in attaining the competency and to evaluate whether the student has satisfied the competency requirements; and
when the selected coach for the competency indicates that the student has satisfied the requirements of the competency, designating the student as having attained that competency; and
when the student has attained each of the competencies for the business career, designating the student as developed in that business career.

2. The method of claim 1 wherein the student is responsible for identifying their own competencies to be attained during the period.

3. The method of claim 1 wherein the student identifies business projects through which the student can satisfy the requirements of a competency.

4. The method of claim 1 wherein the selected coach for a competency assists the student in identifying business projects through which the student can satisfy the requirements of a competency.

5. The method of claim 1 wherein defining a competency includes identifying objective knowledge-based and skill-based requirements for the competency.

6. The method of claim 1 including before identifying competencies for the student, performing a baseline assessment to determine the competencies that the student has already attained.

7. The method of claim 1 wherein the competencies are organized into competency areas.

8. The method of claim 1 including accessing a computer system that provides a description of the competencies and their requirements and provides resources to assist in the satisfying of the requirements.

9. The method of claim 1 wherein the student is responsible for identifying their own competencies to attain during a period, wherein the student identifies business projects through which the student can satisfy the requirements of a competency, and including before identifying the competencies, performing a baseline assessment to determine the competencies that the student has already attained.

10. A method for business career development, comprising:
providing competencies for the business career, each competency having requirements to be satisfied for that competency to be attained;
performing a baseline assessment to determine the competencies that the student has already attained;
for each competency that the student has not attained as indicated by the baseline assessment,
selecting a coach to assist the student in attaining the competency by satisfying the requirements of the competency; and
when the selected coach for the competency indicates that the student has satisfied the requirements of the competency, designating the student as having attained that competency; and
when the student has attained the competencies of the business career, designating the student as developed in that business career.

11. The method of claim 10 wherein the student identifies competencies to be next attained.

12. The method of claim 11 wherein the competencies are identified periodically.

13. The method of claim 10 wherein the student identifies business projects through which the student can satisfy the requirements of a competency.

14. The method of claim 10 wherein the selected coach for a competency assists the student in identifying business projects through which the student can satisfy the requirements of a competency.

15. The method of claim 10 wherein the providing of a competency includes identifying an objective and knowledge-based and skill-based requirements for the competency.

16. The method of claim 10 wherein the competencies are organized into competency areas.

17. The method of claim 10 including accessing a computer system that provides a description of the competencies and their requirements and provides resources to assist in satisfying the requirements.

18. The method of claim 10 wherein the student identifies one or more competencies to be next attained, and wherein the student identifies business projects through which the student can satisfy the requirements of a competency to be attained.

19. A method for project manager development, comprising:
providing competencies for a project manager, each competency having requirements to be satisfied for that competency to be attained;
identifying by a student seeking to become a project manager one or more competencies to be next attained;
for each identified competency,
selecting a coach to assist the student in attaining the competency by satisfying the requirements of the competency; and
when the selected coach for the competency indicates that the student has satisfied the requirements of the competency, designating the student as having attained that competency; and
when the student has attained the competencies of a project manager, designating the student as a project manager.

20. The method of claim 19 wherein the competencies are organized into competency areas that include self-management, team management, and project planning and control.

21. The method of claim 19 wherein the competencies are organized into competency areas that include leadership, financial management, and risk management.

22. The method of claim 19 wherein the competencies are organized into competency areas that include understanding the company.

23. A method for business career development, the method comprising:
providing competencies for the business career, each competency having requirements to be satisfied for that competency to be attained; and
for each provided competency,
selecting a coach to assist a student in attaining the competency by satisfying the requirements of the competency;
when the student has satisfied the requirements of the competency, designating the student as having attained the competency; and
when the student is particularly strong in the competency, devising a plan to increase the student's strength in the competency.

24. The method of claim 23 wherein the coach determines whether the student has satisfied the requirements of a competency.

25. The method of claim 23 wherein the coach determines whether the student is particularly strong in a competency.

26. The method of claim 23 wherein the student periodically identifies competencies to be next attained.

27. The method of claim 23 wherein the devised plan identifies a way to increase the breadth of the student's knowledge and skills in the competency.

28. The method of claim 23 wherein the devised plan identifies a way to increase the depth of the student's knowledge and skills in the competency.

29. The method of claim 23 wherein the requirements of a competency specify a threshold level for the competency and the devised plan for a competency specifies an expert level in the competency.

30. The method of claim 23 including performing a baseline assessment to identify competencies that the student has already attained.

31. The method of claim 23 including performing a baseline assessment to identify competencies that the student has already attained and wherein the student periodically identifies competencies to be next attained, wherein the coach determines whether the student is particularly strong in a competency, and wherein the devised plan identifies way to increase the breadth and depth of the student's knowledge and skills in the competency.

32. A method for business career development, the method comprising:
providing competencies for the business career, each competency having requirements to be satisfied for that competency to be attained;
for each provided competency,
selecting a coach to assist a student in attaining the competency by satisfying the requirements of the competency; and
when the student has consistently demonstrated over time satisfaction of the requirements of the competency, designating the student as having attained the competency; and
when the student has attained each of the provided competencies, designating the student as developed in that business career.

33. The method of claim 32 wherein the requirements define a threshold level of proficiency in the competency.

34. A method for business career development, the method comprising:
providing competencies for the business career, each competency having requirements to be satisfied for that competency to be attained;
for each provided competency,
selecting a coach to assist a student in attaining the competency by satisfying the requirements of the competency; and
when the student has satisfied the requirements of the competency, designating the student as having attained the competency; and
periodically performing a baseline assessment to determine whether the student still satisfies the requirements of competencies already attained.

35. The method of claim 34 wherein when it is determined that the student no longer satisfies the requirements of a competency, already attained, developing a plan for the student to satisfy the requirements of the competency.

36. A method for business career development of a student, the method comprising:
providing competencies for the business career, each competency having requirements to be satisfied for that competency to be attained;
performing an initial baseline assessment to identify competencies that the student has already attained;
identifying by the student of competencies to be next attained;
for each identified competency,
selecting a coach to assist a student in attaining the competency by satisfying the requirements of the competency;
when the student has satisfied the requirements of the competency, designating by the selected coach that the student has attained the competency; and
when the student is particularly strong in the competency, devising a plan to increase the student's strength in the competency;
periodically performing a baseline assessment to determine whether the student still satisfies the requirements of competencies already attained; and
when the student has attained each of the competencies for the business career, designating the student as developed in that business career.
